(19) United States
(12) Patent Application Publication
(10) Pub. No.: US 2026/0326149 A1
(43) Pub. Date: Oct. 22, 2026

(54) Dedusting Apparatus Control System Utilizing Sensors to Minimize Product Carryover

(71) Applicant: Pelletron Corporation, Lancaster, PA (US)

(72) Inventors: Louis S. Schwartz, Lancaster, PA (US); Sean Schmuck, Lancaster, PA (US)

(73) Assignee: Pelletron Corporation, Lancaster, PA (US)

(21) Appl. No.: 19/648,249

(22) Filed: Apr. 15, 2026

Related U.S. Application Data
(60) Provisional application No. 63/790,116, filed on Apr. 17, 2025.

(51) Int. Cl. B07B 11/04; B07B 4/02; B07B 11/02; G05B 19/05

(52) U.S. Cl. CPC B07B 11/04; B07B 4/02; B07B 11/02; G05B 19/058

(57) ABSTRACT

A control system for operating a dedusting machine is operable to adjust the operation of major and minor components to vary the CMFR calculated from the operation of an impact sensor apparatus placed into the flow stream of dirty air discharged from the dedusting machine. The impact sensor apparatus includes an impact plate against which the impact of carryover product generates a vibration signal that is identified by a piezoelectric censor and transmitted to the PLC to calculate the CMFR. The control system manipulates the major components to adjust the control parameters until the CMFR reaches an acceptable range of CMFR values stored in the PLC. The control system also adjusts minor control parameters to further reduce the CMFR after reaching the acceptable value within the range of values stored in the PLC.

### CROSS-REFERENCE TO RELATED APPLICATIONS

This application claims domestic priority on U. S. Provisional Patent Application Serial No. 63/790,116, filed on Apr. 17, 2025, the content of which is incorporated herein by reference.

### FIELD OF THE INVENTION

The present invention generally relates to dedusting devices for removing dust and debris from particulate material such as plastic resin materials in pelletized, flake, or granular form and, more particularly, to a control system that automatically adjusts operational parameters to maintain required mass throughput with best cleaning performance while preventing excessive product carryover.

### BACKGROUND OF THE INVENTION

It is well known, particularly in the field of transporting and using particulate materials, commonly powders, granules, pellets, and the like, that it is important to keep product particles as free as possible of contaminants. Particulates are usually transported within a facility where they are to be mixed, packaged or used in a pressurized tubular system that in reality produces a stream of material that behaves somewhat like a fluid. As these materials move through the pipes, considerable friction is generated not only among the particles themselves, but also between the tube walls and the particles in the stream. In turn, this friction results in the development of particle dust, broken particles, fluff, streamers (ribbon-like elements), and fibers in glass filled products, that can impede the flow of materials. The characteristics of such a transport system are quite well known, as is the importance and value of keeping product particles as free as possible of contaminants.

The term “contaminant” as used herein includes a broad range of foreign material and includes foreign material as well as broken particles or streamers of the product being transported. The generation of contaminants, also referred to as dust, including microdust, can be from a large number of sources, including, in the way of examples, the creation of dust particles during the processing of plastic pellets in which the larger particles are segregated to be re-ground; organic matter in food grains, such as shells and hulls; the creation of dust in the formation of iron ore pellets; and, as noted previously, the mere conveyance of the pellets in pipes and other mechanical conveying and handling systems. Using plastics as an example, such foreign material could have a detrimental effect on the finished product. Specifically, foreign material different in composition from the primary material, such as dust, and non-uniform material of the primary product, such as streamers, would not necessarily have the same melting temperatures as the primary product and would cause flaws when the plastics material is melted and molded. Furthermore, streamers can impact the weighing scale and plug the dosing screws at bagging stations.

Considering product quality, and focusing on moldable plastics as a primary example, foreign material different in composition from the primary material, such as dust, non-uniform material of the primary product, fluff, and streamers, does not necessarily have the same melting temperatures as the primary product and causes flaws when the material is melted and molded. These flaws result in finished products that are not uniform in color, may contain bubbles, and often appear to be blemished or stained, and are, therefore, unsellable. It is important to note that since these same non-uniform materials often do not melt at the same temperature as the primary product, the unmelted contaminants cause friction and premature wear to the molding machines, resulting in downtime, lost production, reduced productivity, increased maintenance and thus increased overall production costs.

Since dust and other contaminants are generated mostly by the transport system, it is of primary importance to not only provide apparatus for thoroughly cleaning the particles, but to do so as close to the point of use of the particles as possible so as to avoid the generation of contaminants through additional transport. Accordingly, compact dedusting devices have been used for many years to clean materials in this application, capable of handling smaller volumes of product, yet also capable of thoroughly cleaning the product. The compact dedusting devices permit the installation of the deduster immediately before final use of the products, such as being installed directly on top of molding machines or extruders, or on top of silos, as well as under silos, before packaging and bagging, rather than at an earlier stage after which re-contamination can occur before the products are utilized. Of course, the dedusting devices can be installed as a free standing unit, as well.

Dedusting devices used to clean contaminants from particulate material can be found in U. S. Patent No. 5,035,331, granted to Jerome I. Paulson on Jul. 30, 1991, in which air is blown upwardly through wash decks over which a flow of contaminated particulate material is passed so that the flow of air up through the wash decks removes the contaminants from the material flow. A magnetic field is provided by the deduster so that the particulate material flow passes through the magnetic field to neutralize the static charge on the particulates and facilitate the removal of the contaminants from the material. The flow of contaminant laden air is discharged from the deduster, while the cleaned particulate material is passed on to the manufacturing process.

A compact dedusting apparatus is disclosed in U. S. Patent No. 6,595,369, granted on Jul. 22, 2003, to Jerome I. Paulson. Like the larger dedusting apparatus depicted in U. S. Patent No. 5,035,331, the follow of particulate material is cleansed of contaminates that have had the static charged attracting the contaminates to the particulates neutralized. The cleaning process utilizes a flow of air passing through the stream of particulate material passing over wash decks. The contaminate-laden air is discharged through the top of the dedusting apparatus, while the cleaned particulate material is discharged from the bottom of the deduster.

In U. S. Patent No. 7,380,670, granted on Jun. 3, 2008, to Jerome I. Paulson, et al, and in U. S. Patent No. 8,016,116, granted on Sep. 13, 2011, to Heinz Schneider, the dedusting apparatus includes a pair of oppositely directed wash decks receiving contaminated particulate material from a common infeed port. The infeed mechanism divides the material flow between the two opposing wash decks and directs the particulate material over a flow of air passing through the first wash decks, then through laterally spaced Venturi zones and onto inwardly directed secondary wash decks that direct the cleaned particulate material into a central discharge opening. Air flow to the primary and secondary wash decks is directed through a rearwardly located manifold that has a central primary opening and laterally spaced lower openings below the secondary wash decks.

The use of accelerometers on an impact plate to detect particulate materials within an air flow is known in the art, particularly for agricultural machinery. As an example, U. S. Patent No. 8,504,310, granted on Aug. 6, 2013, to Deere & Company, discloses an impact sensor within a distribution tower of an air seeder device in which the impact sensor creates a force signal corresponding to seeds hitting the impact plate. The force signal is sent to a processor to determine the particulate mass flow rate so that the rate of application of seed and fertilizer can be determined. In U. S. Patent No. 9,474,208, granted on Oct. 25, 2016, to Apparco Systems , LLC, utilizes an impact sensor to define the yield of a harvesting machine.

U. S. Patent No. 9,958,301, granted to Clemson University on May. 1, 2018, discloses a force system on a peanut harvesting machine that intercepts a flow of air bearing the harvested peanuts to determine the mass flow rate from peanuts hitting the impact sensor, which can be correlated to the crop yield. In U. S. Patent No. 5,010,827, granted to Wyerhaeuser Company on Apr. 30, 1991, an impact sensor registers impacts of material being carried over in a smelting furnace, which in turn is indicative of the count of carryover particles. An operator can make control corrections to reducing an excessive number of carryover particles.

Currently carryover levels for dedusting machines are determined manually by dry sieving and analyzing discarded material. Carryover levels may not be routinely examined by customers, resulting in significant good product loss and lower profit margins. Most operators of these dedusting machines find the process of evaluating product carryover for large systems to be difficult and time consuming and typically not possible during machine operation. An additional difficulty arises when multiple systems are vented to a single dust collection point to accurately identify carryover from a single dedusting machine. Adjusting operating parameters of current dedusting machines currently requires manual adjustments to adjust system performance and carryover levels. Also, traditional locations of dedusting machine, such as on the top of silos, make routine access of equipment difficult to complete on-going operating adjustments. Operating parameter adjustments require trained personnel which may not always be available, or onsite personnel may contain limited knowledge preventing optimal performance of the equipment following material change overs, system maintenance, filter changes, and changes in ambient conditions (most systems located outdoors).

It would be desirable to provide a control system that uses an impact sensor to provide an indication of the amount of product carryover to allow a processor to take corrective measures with respect to major and minor operational parameters without requiring input from an operator.

### SUMMARY OF THE INVENTION

It is an object of this invention to overcome the disadvantages of the known prior art by providing a control system for a dedusting machine.

It is another object of this invention that the control system provides an automated operation of the dedusting machine.

It is a feature of this invention that the control system is operable to control operative functions within the dedusting machine in an autonomous manner to maintain efficiency of operations of the dedusting machine.

It is another feature of this invention that the product carryover in the discharge of dirty air from the dedusting operation of the machine can be monitored to determine that amount of carryover.

It is an advantage of this invention that the dedusting machine includes a microprocessor that can calculate the Carryover Mass Flow Rate (CMFR) from the monitoring of the flow of dirty air from the dedusting machine.

It is still another feature of this invention that the monitoring of the flow of dirty air from the dedusting machine includes an impact apparatus that identifies the carryover product within the dirty air flow.

It is another advantage of this invention that the impact apparatus includes an impact plate oriented to intercept the flow of dirty air and register a vibration signal corresponding to each impact of product on said impact plate.

It is still another object of this invention to identify major control parameters that are manipulated to change the CMFR.

It is yet another feature of this invention that the control system manipulates the operation of the controlled devices to cause a variation in the CMFR until the CMFR falls within a range of values stored within the PLC.

It is a further feature of this invention that the control system changes other control parameters to lower the CMFR even after the control system has reached a CMFR value that is within the range of CMFR values stored within the PLC.

It is yet another advantage of this invention that the control system continues to monitor the CMFR and makes adjustment of the control parameters to maintain the CMFR within acceptable rates as stored within the PLC.

It is still another feature of this invention that the control system for controlling the operation of a dedusting machine includes remotely operable devices that can be adjusted by the PLC to change the CMFR of the dedusting machine.

It is still another advantage of this invention that the control system can adjust the wash air flow the position of the deflectors relative to the wash decks, the rate of fresh air added by the bleed air device to control the flow of breather air entering the dedusting machine through the product discharge opening, the fan speed of the exhaust fan, the position of the Venturi deflectors and air bypasses to control air flow through the Venturi zones.

It is a further feature of this invention that the control system can speed up or slow down the motor feeding air into the dedusting machine.

It is still a further object of this invention to provide a control system for a dedusting machine that is simple and effective in use.

These and other objects, features and advantages are accomplished according to the instant invention by providing a control system for operating a dedusting machine that can adjust the operation of major and minor components to vary the CMFR calculated from the operation of an impact sensor apparatus placed into the flow stream of dirty air discharged from the dedusting machine. The impact sensor apparatus includes an impact plate against which the impact of carryover product generates a vibration signal that is identified by a piezoelectric sensor and transmitted to the PLC to calculate the CMFR. The control system manipulates the major components to adjust the control parameters until the CMFR reaches an acceptable range of CMFR values stored in the PLC. The control system also adjusts minor control parameters to further reduce the CMFR parameters to further reduce the CMFR after reaching the acceptable value within the range of values stored in the PLC.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a diagrammatic diagram of a dedusting system for cleaning dirt and debris from a flow a particulate material fed into the dedusting machine, incorporating the principles of the instant invention;

FIG. 2 is a schematic front elevational view of a dedusting machine similar to the dedusting machine shown in the system depicted in FIG. 1, but not showing the control system incorporating the principles of the instant invention, this drawing figure has been included from an earlier patent to help explain the operation of the dedusting machine to remove dirt and debris from the flow of particulate material received thereby;

FIG. 3 is a schematic top plan view of the dedusting machine shown in FIG. 2 to aid in the explanation of the operation of the dedusting machine;

FIG. 4 is a schematic cross-sectional view of the impact sensor placed into the flow path of the dirt and debris laden cleaning air discharged from the dedusting machine to identify the number of carryover particulates in the air flow; and

FIG. 5 is a logic flow diagram showing the operation of the control system for operation of the dedusting system.

### DETAILED DESCRIPTION OF THE PREFERRED EMBODIMENT

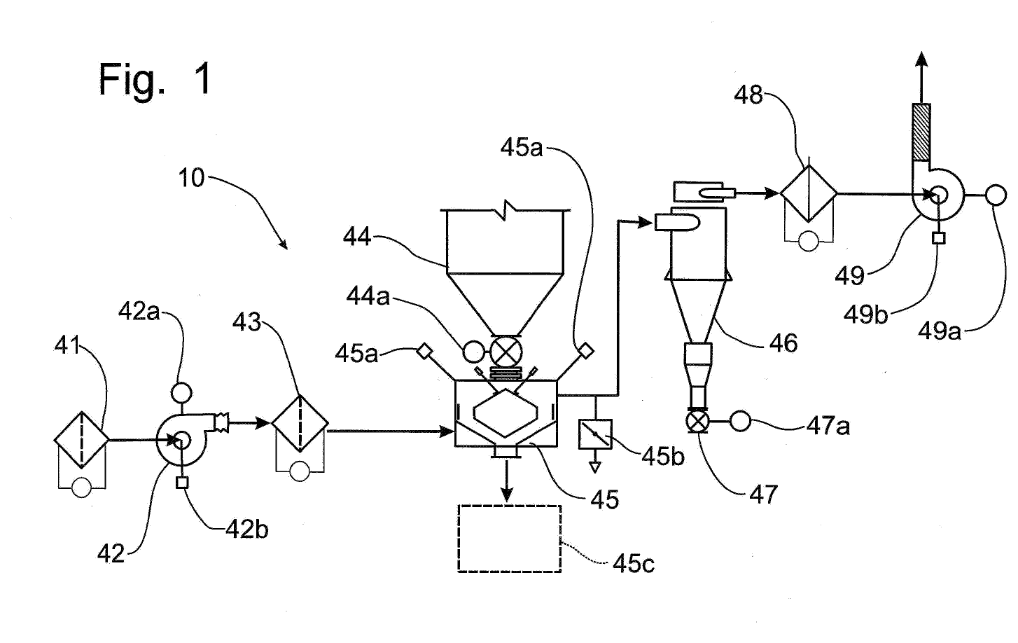

Referring to FIGS. 1, 4 and 5, a schematic view of a dedusting system incorporating the principles of the instant invention can best be seen. The dedusting machine 10 is constructed in the manner defined in Applicant’s U. S. Patent No. 8,016,116, and having a pair of wash decks positioned in a back-to-back relationship.

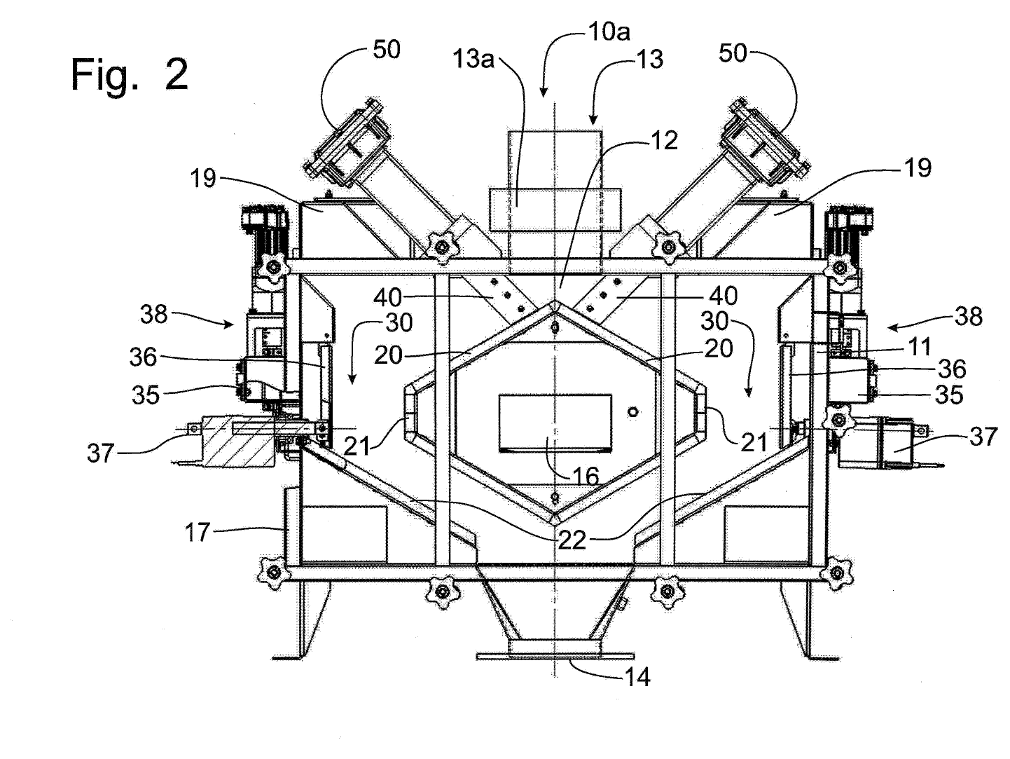

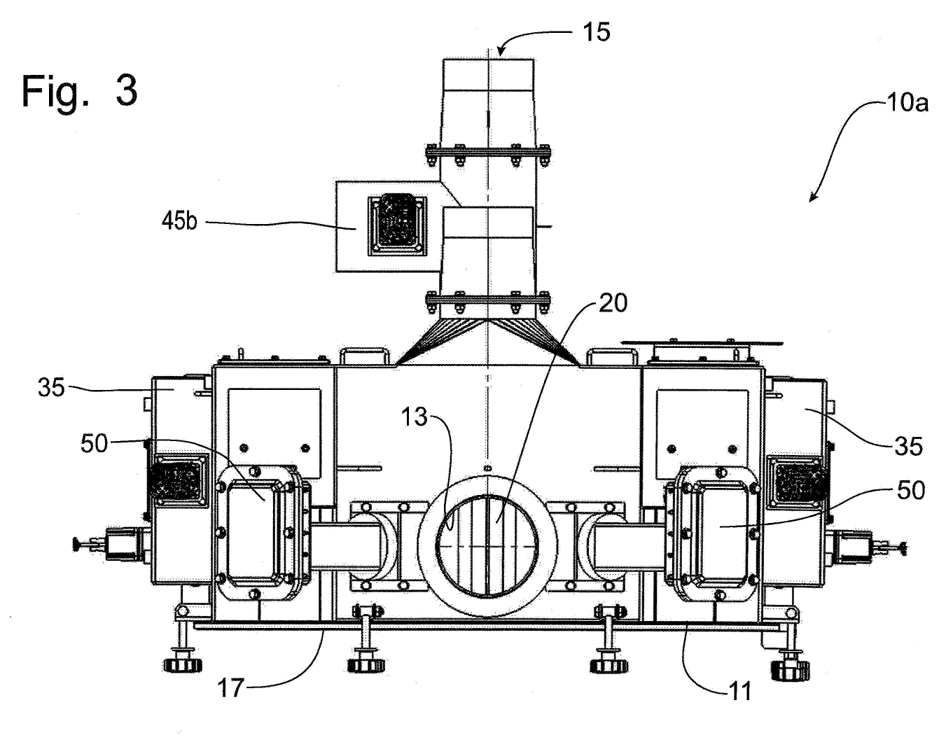

Referring now to FIGS. 2 and 3, the operation of the dedusting machine can be explained. The dedusting apparatus 10a defines a central product inlet port 13 that is typically connected to a vertical portion of a fluent material handling system (not shown) such that the particulate material is fed into a product inlet port 13 located at the transverse center at the top of a generally airtight main housing 11. The main housing 11 supports a pair of oppositely directed wash decks 20 that receive particulate material to be cleaned from the inlet port 13, as will be described in greater detail below. The main housing also defines an air inlet passageway 15 having an air inlet port 16 in the rear wall 12 of the housing 11. As will be described in greater detail below, the introduction of an air flow through the air inlet port 16 will direct air through the wash decks 20 to clean the particulate material.

The product inlet port 13 directs product particulates onto the wash decks 20 for cleaning. A magnetic coil 13a generates a magnetic flux field and is mounted at the inlet port 13 so that the flow of particulate material into the main housing 11 to be cleaned is subjected to the magnetic flux field to neutralize the static charges on the particulate pellets, thus making the separation of the contaminates, particularly microdust, from the pellets easier to accomplish. Air is fed into the housing 11 through the clean air inlet port 16 through the rear wall 12 to direct a flow of clean air into the housing 11, as will be described in greater detail below. A portion of the clean air passing through the inlet opening 16 is directed upwardly through the wash decks 20, while a remaining portion of the clean air flowing into the housing 11 is distributed to the Venturi zones 30, as will be described in greater detail below.

The wash decks 20 are supported by the housing 11 between the front wall 17 and the rear wall 12 to present a downwardly sloping surface in opposite directions from the product inlet port 13 to the discharge ends of the wash decks 20 over which the product to be cleaned, in the form of particulate particles, moves by gravity. The particulate material falls through the Venturi zones 30 and lands on the secondary wash decks 22 where an additional cleansing air flow is encountered by the particulate material before being passed to the product outlet port 14.

A pair of inlet deflectors 40 is mounted to the housing to control the flow of material over the surface of the upper wash decks 20. The greater the gap between the inlet deflector 40 and the wash deck, the higher the flow rate will be. The inlet deflector 40 includes a trailing leg that is oriented generally parallel to the slope of the wash deck 20 to force the product particulates into a laminar flow downwardly over the surface of the wash deck 20 toward the Venturi zone 30 after passing the inlet deflector 40. Linear actuators 50 are connected to the deflectors 40 to selectively move the deflectors 40 and the corresponding trailing legs toward and/or away from the upper wash decks 20.

The wash deck 20 is formed as a sloped tray having a top surface in which is formed generally horizontal slots and circular openings, as is well known in the art. The horizontal slots are formed in conjunction with an upwardly extending deflector that presents a ramp to the product particulates moving downwardly over the top surface of the wash deck 20. The slots are formed as the horizontal opening across the top surface between the deflectors and the top surface of the wash deck 20, such that the air flowing through the slots is directed by the deflectors into the product in a generally horizontal direction, which is slightly upwardly with respect to the slope of the top surface of the wash deck 20. Air moving through the circular openings is directed generally perpendicularly to the sloped top surface of the wash deck 20.

The net operative result is that the product particulates are subjected to a downward acceleration along the surface of the wash deck and to a turbulence generated by the movement of the particulates over the deflectors and by the substantially perpendicular air flow streams emanating from the circular openings and the horizontal slots. Accordingly, dust and debris contaminates are released from the product particulates and are carried by the air flow to the dirty air exhaust port 19 at the top of the housing 11.

The product particulates falling off of the lower discharge end 21 of the respective wash decks 20 drop generally vertically toward the corresponding secondary wash decks 22 through a Venturi zone 30 through which air, including breather air entering the housing 11 through the product discharge port 14, is blown upwardly through the falling product particulates to provide a vigorous final cleaning. Air is directed into the Venturi zone 30 from beneath the wash deck 20 through louvers and through air vents passing through the secondary wash decks 22, as is known in the art. Clean air can also be directed into the Venturi zones 30 through the bypass ducts 35. The main housing 11 is provided with a clean air plenum or manifold behind the rear wall 12 and is in flow communication with the clean air inlet opening 16 to direct a flow of air into the wash decks 20, 22, and into the bypass ducts 35.

The bypass ducts 35 which direct a flow of air forwardly around the main housing 11 and back into the main housing 11 in front of the rear wall 12 to be directed behind and under the pivoted members 36 into the Venturi zones 30. The velocity of air moving through the bypass ducts 35 is controlled by dampers 38 pivotally mounted in the bypass ducts 35. The size of the Venturi zones 30 and the velocity of the air flow directed into the Venturi zones 30 is controlled by the pivoted deflector member 36 operatively connected to a powered position adjustment lever 37 projecting outside of the main housing 11.

The flow of air into the Venturi zone 30 from beneath the pivoted member 36 and through the louvers presents a substantial cleaning action to the product particulates falling through the Venturi zone 30, but not so vigorous as to lift the product particulates to the dirty air exhaust port 19. If too much air is moving through the Venturi zone 30, the pivoted dampers 36 should be retracted to both increase the effective dimensions of the Venturi zone 30 and to decrease the velocity of air moving into the Venturi zone 30. When the front wall 17 of the housing 11 is preferably constructed of glass or a transparent or semi-transparent polycarbonate, as is reflected in the drawings although shown in an opened position, the operation of the wash deck assembly 20 could be physically viewed by looking through the front wall 17 to see if product particulates were being carried over into the dirty air exhaust port 19.

The air flow in which the dust and debris contaminates are entrained is discharged from the housing 11 through the dirty air exhaust port 19 located at the top of the housing 11 above the Venturi zone 30 and on opposite sides of the product inlet port 13. The transparent front wall 17 of the housing 11 can be formed as a hinged door with a handle (not shown) to facilitate movement of the front door 17 when released from the housing frame 11. Alternatively, the front wall 17 is not hinged and can be removed by releasing appropriate fasteners 17a connecting the front wall 17 to the housing frame 11. With the displacement of the front wall 17, the interior components, including the wash deck 20, the inlet deflector 40, and the pivoted member 36, can be removed from the housing 11 to facilitate cleaning of the interior of the housing 11 and the removed components.

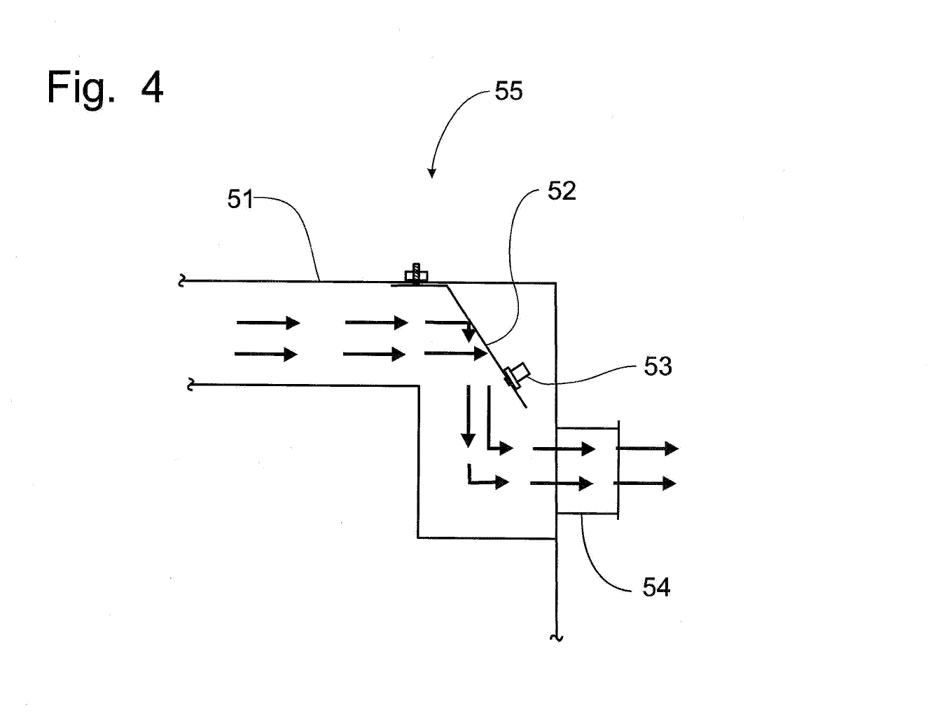

The instant invention, as best seen in FIGS. 1, 4 and 5 enhances the operation of the dedusting machine for debris and dust removal to clean plastic resin materials in pelletized, flake, or granular form. The instant invention can also be applied to other materials such as pet food and aluminum processing, as well as any other applications requiring separation of smaller unwanted debris from larger particles. The instant invention includes an ability to measure the amount of good product lost in the unwanted debris stream, enabling adjustments to the process to minimize product loss. Alternatively, the adjustments can be utilized to “set” the good pellet loss at a level that is not the minimum but provides better cleaning performance. One of ordinary skill in the art will recognize that higher wash air flow (and velocity in the Venturi zone) will remove more unwanted particles but with the consequence that more good product will be lost, which may be acceptable to the user. That ability is provided by the control system 60 which includes an impact sensor 55. The impact sensor 55 is mounted in the air discharge path, such as shown in FIGS. 2 and 3 as the air discharge conduit 19, referenced as 54 in FIG. 4. An impact plate 52 is mounting to the housing 51 to be oriented at an angle to the flow of dirty air. Any particulates that are entrained in the air flow will impact the plate 52 such that the resonation will be picked up by the vibration sensor 53, preferably a piezoelectric sensor, which transmits the vibration signal to a microprocessor (not shown), such as a Programmable Logic Controller (PLC).

Referring to FIG. 1, the dedusting system 10 preferably begins with an inlet filter 41 that filters the air being drawn into the fan 42 that discharges the air into the dedusting machine 45 after passing through an optional HEPA filter or alternatively a fabric filter dust collector or other dust collection apparatus 43. This clean air is conveyed into the dedusting machine 45, as is described above with respect to FIGS. 2 and 3, to blow through the wash decks 20 and clean the dirt and debris from the particulate matter fed into the dedusting machine 45 from the hopper 44 through the rotary valve interconnecting the hopper 44 and the dedusting machine 45. The cleaned particulate material is discharged from the dedusting machine 45 through an outlet opening into a device 45c that will ultimately deliver the cleaned material to a manufacturing site. The device 45c can be a bagging device, a truck, a railway car, a pneumatic conveyor, or an extruder. The dirty air is then received by a cyclone 46 that separates the dirt and debris from the air. The solids are then collected in the bottom of the cyclone 46, and ultimately pass through a rotary valve 47 for disposal. The air that had these solids entrained therein continues through an inline filter 48 and into an exhaust air fan 49 for discharge through additional filters into the atmosphere.

The controls system 60 includes motors 42a, 44a, and 49a that powers the rotation of the fan 42, the rate of feeding uncleaned particulate material into the dedusting machine 45 and the rate of speed of the exhaust fan 49. In addition, the control system 60 includes various sensors, position sensors, linear actuators, pressure sensors, temperature sensors, air velocity sensors, artificial intelligence vision systems, load cells, vibration sensors, fan speed, operation of the bleed air device 45b and damper controls. The devices are identified as 42b, 45a and 49b in FIG. 1.

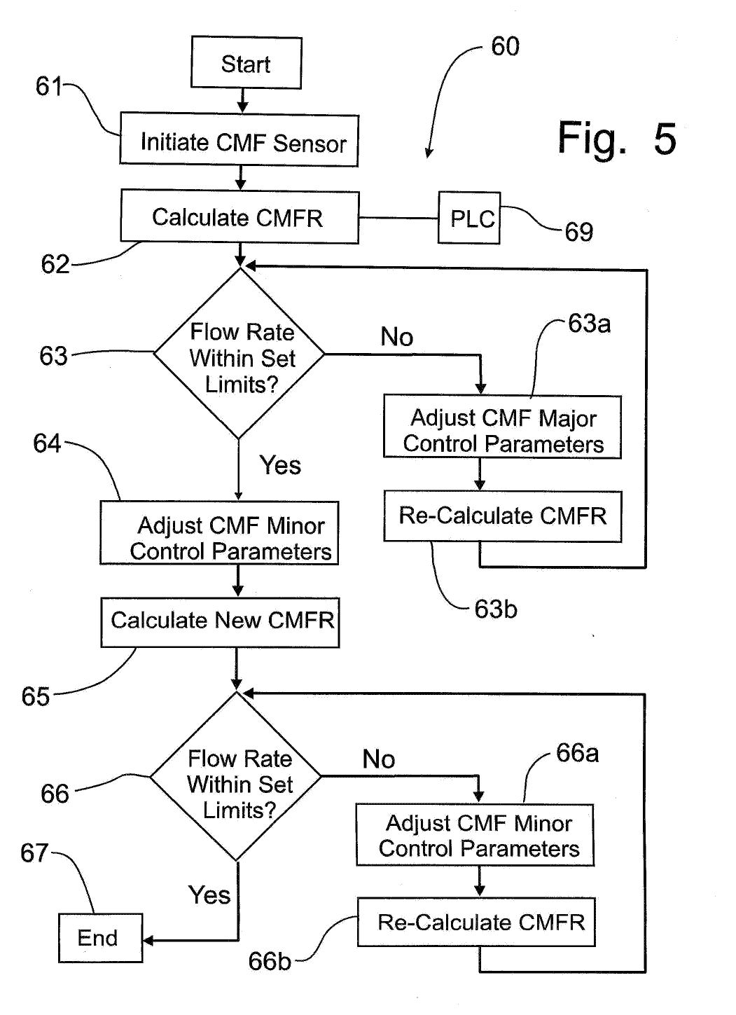

The operation of the control system 60 is reflected in the logic flow chart of FIG. 5 representing a control loop for the system. This control loop begins with the initiation of the Carryover Mass Flow (CMF) sensor, which is primarily the vibration sensor 53, at step 61. Once initiated the control system calculates at step 62 the Carryover Mass Flow Rate, which is a function of the signals the PLC 69 receives from the vibration sensor 53 . The PLC 69 then compares Carryover Mass Flow Rate to the range of acceptable carryover that is stored in the PLC. If the Carryover Mass Flow Rate is outside the limits stored within the PLC 69, the control system 60 adjusts the major parameters of the system at step 63a, and then re-calculates the Carryover Mass Flow Rate at step 63b and returns to step 63 to determine if the Carryover Mass Flow Rate is within the acceptable limits stored in the PLC 69. This sub-loop of steps 63a. 63b and 63 are repeated until the Carryover Mass Flow Rate is within the accepted parameters.

When the calculated Carryover Mass Flow Rate is within the stored acceptable limits, the PLC 69 can make some adjustment to minor control parameters at step 64 in an attempt to lower the Carryover Mass Flow Rate. Then the control system 60 calculates a new Carryover Mass Flow Rate at step 65 and compares the new rate with the acceptable limits at step 66. If the new Carryover Mass Flow Rate is not within the accepted limits, then a second sub-loop is engaged. The control system 60 further adjusts the minor control parameters at step 66a, then recalculates the Carryover Mass Flow Rate at step 66b and compares the recalculated rate with the acceptable limits at step 66. This sub-loop of steps 66a, 66b and 66 continues until the recalculated rate falls within the accepted limits and the loop passes to step 67 and the sub-loop is ended.

The major control parameters for this control system are the wash air flow, the speed of the exhaust fan and the operation of the bleed air/fresh air device 45b to control the air fed into the dedusting machine 10a. Thus, the control system 60 can speed up or slow down the motor 42a that feeds air at velocity into the dedusting machine 45. The flow rate of uncleaned material passing into the dedusting machine from the hopper 44 can be increased or decreased by changing the speed of rotation of the rotary valve through which the material is passed into the inlet opening of the dedusting machine 45 or by adjusting the actuated inlet dampers 40. The rate of fresh air added to the flow of dirty air to the cyclone 46 by the bleed air/fresh air device 45b will control the flow of breather air entering the dedusting machine 45 through the product discharge opening. Minor control parameter would include the positioning of the Venturi deflectors 36 and the operation of the air bypass dampers 38 within the air bypass ducts 35 to control air flow through the Venturi zones 30.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiments of the invention; however, concepts, as based upon the description, may be employed in other embodiments without departing from the scope of the invention.

In the way of an example, instead of using an impact plate with a piezoelectric vibration sensor to detect material carryover, an optical sensor can be employed to identify pellets and other particles within the air stream. Such a sensor measures the quantity of material above a specified dimensional threshold and sends an electrical signal indicating the calculated carryover. One skilled in the art will recognize that such a control system 60 can be used as a “bolt-on kit” to update older dedusting machines. One skilled in the art will also recognize that the operating parameters, as well as the acceptable limits for the Carryover Mass Flow Rate can be adjusted to meet the needs and desires of the customer operating the dedusting machine 45, and also adjusted to change the operating parameters to conform to the material being cleaned by the dedusting machine 45.

Instead of using an impact plate with a piezoelectric vibration sensor to detect material carryover, an optical sensor can be employed to identify pellets and other particles within the air stream. The sensor measures the quantity of material above a specified dimensional threshold and sends an electrical signal indicating the calculated carryover. If this carryover exceeds the default threshold, the PLC automatically adjusts major and minor process parameters to maintain acceptable levels and optimize cleaning performance.

However, optical sensors have limitations that affect their usability in this application. They operate in a 2D plane, potentially causing particles farther from the sensor to appear smaller than they are, leading to inaccuracies in size measurement. Moreover, these sensors and their necessary components may lack the electrical safety ratings required for deployment in many environments where these systems are used. Additionally, the cost of optical sensors, including required data processors and front/backlighting components, is significantly higher compared to the current solution.

While the optimal control system location is internal to the dedusting machine housing located in the top section immediately after the plenum and carryover deflector. However, secondary control system locations can be anywhere in line of the dirty air flow. Examples of appropriate secondary locations are external to the dedusting machine with inlet and outlet hoses/ pipes inline to the dust collection system. Inlet of dust collections system (i.e. cyclone inlet process connection, baghouse inlet, etc.).

What is claimed is:

1. A control system for a dedusting system having:a dedusting machine including:a housing defining a product inlet opening through which unclean particulate material is introduced into said housing, an inlet air opening through which clean air is introduced into said housing, a discharge air opening through which dirty air is discharged from the housing, and a product discharge opening through which cleaned particulate material is discharged from said housing;at least one wash deck supported within said housing to received unclean particulate material from said product inlet opening, said wash deck including openings through which clean air passes to remove dust and debris from the unclean particulate material, the flow of air passing through said at least one wash deck continuing to said air discharge opening;at least one deflector operable to direct said unclean particulate material into a laminar flow across said at least one wash deck, said at least one deflector being coupled to a linear actuator to selectively move said deflector relative to said wash deck to vary a thickness dimension of said particulate material within said laminar flow;at least one adjustable air bypass vent to control air flow within said housing including a damper operable connected to said at least one air bypass vent; and a bleed air device having a movable damper for controlling the rate of air flow into said housing through said product discharge opening;
a source of clean air blown into said inlet air opening;
an air cleaning apparatus operably connected to said discharge air opening to remove dust and debris entrained into the flow of air passing through said discharge air opening, said air cleaning apparatus including a source of air movement to draw said dirty air through said air cleaning apparatus; and
a supply of unclean particulate material connected to said product inlet opening and including a metering device that controls a rate at which said unclean product is introduced through said product inlet opening, comprising:
a microprocessor operable to calculate a carryover mass flow rate as a function of the amount of particulate material entrained within said dirty air passing through said discharge air outlet, said microprocessor having stored therein a range of acceptable values of carryover mass flow rate;
a sensor detecting a presence of particulate material carryover within said flow of dirty air discharged from said discharge air opening, and sending a signal to said microprocessor indicative of the rate at which particulate material carryover is detected;
a control device operably connected to said metering device, said source of clean air, said source of air movement, said at least one actuator connected to said at least one deflector, said bleed air damper and said damper controlling air flow through said at least one bypass vent, each said control device sending a signal representative of the operation thereof to said microprocessor, said microprocessor being operative to change operational parameters of selected said control devices to change the calculate carryover
mass flow rate until the calculated mass flow rate falls within the range of acceptable values of carryover mass flow rate stored within said microprocessor.

2. The control system of claim 1 wherein selected ones of the control devices are predetermined to be major control devices with the remainder being classified as minor control devices.

3. The control system of claim 2 wherein said microprocessor adjusts the operating parameters of selected major control devices if the calculated carryover mass flow rate is outside of the stored range of acceptable carryover mass flow rates, and repeats adjustment of major control devices until the calculated carryover mass flow rate falls within the stored range of acceptable carryover mass flow rates.

4. The control system of claim 3 wherein after the calculated carryover mass flow rate has fallen into the stored range of acceptable carryover mass flow rates, said microprocessor adjusts operative parameters of minor control devices to lower the carryover mass flow rate within said stored range of acceptable carryover mass flow rates.

5. The control system of claim 1 wherein said sensor detecting a presence of particulate material carryover within the flow of dirty air discharged from the discharge air opening is an impact sensor mounted within the flow of dirty air.

6. The control system of claim 5 wherein said impact sensor comprises:
an impact plate positioned to intercept the flow of dirty air discharged from the discharge air opening so that carryover particulate material entrained within the dirty air generates a vibration signal as a result of acceleration or impact strength upon impact;
and a vibration sensor associated with said impact plate to register each said acoustic sound and send a corresponding signal to said microprocessor.

7. The control system of claim 6 wherein said vibration sensor is a piezoelectric sensor.

8. The control system of claim 1 wherein said sensor detecting a presence of particulate material carryover within the flow of dirty air discharged from the discharge air opening is an optical sensor mounted to detect carryover particulate material within the flow of dirty air.

9. The control system of claim 1 wherein said microprocessor is a Programmable Logic Controller.

10. A method of controlling the operation of a dedusting system having:a dedusting machine including:a housing defining a product inlet opening through which unclean particulate material is introduced into said housing, an inlet air opening through which clean air is introduced into said housing, a discharge air opening through which dirty air is discharged from the housing, and a product discharge opening through which cleaned particulate material is discharged from said housing;at least one wash deck supported within said housing to received unclean particulate material from said product inlet opening, said wash deck including openings through which clean air passes to remove dust and debris from the unclean particulate material, the flow of air passing through said at least one wash deck continuing to said air discharge opening;at least one deflector operable to direct said unclean particulate material into a laminar flow across said at least one wash deck, said at least one deflector being coupled to a linear actuator to selectively move said deflector relative to said wash deck to vary a thickness dimension of said particulate material within said laminar flow;
and at least one adjustable air bypass vent to control air flow within said housing including a damper operable connected to said at least one air bypass vent;a source of clean air blown into said inlet air opening;an air cleaning apparatus operably connected to said discharge air opening to remove dust and debris entrained into the flow of air passing through said discharge air
opening, said air cleaning apparatus including a source of air movement to draw said dirty air through said air cleaning apparatus; anda supply of unclean particulate material connected to said product inlet opening and including a metering device that controls a rate at which said unclean product is introduced through said product inlet opening, comprising the steps of:providing a microprocessor operable to calculate a carryover mass flow rate as a function of the amount of particulate material entrained within said dirty air passing through said discharge air outlet, said microprocessor having stored therein a range of acceptable values of carryover mass flow rate;detecting a presence of particulate material carryover within said flow of dirty air discharged from said discharge air opening by a sensor;sending a signal from said sensor to said microprocessor indicative of the rate at which particulate material carryover is detected;adjusting operating parameters of selected control devices operably connected to said metering device, said source of clean air, said source of air movement, said at least one actuator connected to said at least one deflector, and said damper controlling air flow through said at least one bypass vent to change the carryover mass flow rate until said carryover mass flow rate falls within said range of acceptable values of carryover mass flow rate stored in said microprocessor.

11. The method of claim 10 wherein said dedusting machine further includes a bleed air device having a movable damper operable to control the flow of fresh air into said dedusting machine thorough the product discharge opening, said method further comprising the step of:controlling the position of said bleed air device damper as a function of the calculated carryover mass flow rate.

12. The method of claim 11 wherein selected ones of the control devices are predetermined to be major control devices with the remainder being classified as minor control devices.

13. The method of claim 12 wherein said microprocessor is a Programmable Logic Controller (PLC) that is operable to adjust the operating parameters of selected control devices if the calculated carryover mass flow rate is outside of the stored range of acceptable carryover mass flow rates, and repeats adjustment of major control devices until the calculated carryover mass flow rate falls within the stored range of acceptable carryover mass flow rates stored within the PLC.

14. The control system of claim 13 wherein, after the calculated carryover mass flow rate has fallen into the stored range of acceptable carryover mass flow rates, said microprocessor adjusts operative parameters of other control devices to lower the carryover mass flow rate within said stored range of acceptable carryover mass flow rates.

15. The control system of claim 10 wherein said sensor detecting a presence of particulate material carryover within the flow of dirty air discharged from the discharge air opening is an impact sensor apparatus mounted within the flow of dirty air.

16. The control system of claim 15 wherein said impact sensor apparatus comprises:an impact plate positioned to intercept the flow of dirty air discharged from the discharge air opening so that carryover particulate material entrained within the dirty air generates a vibration response as a result of acceleration or impact strength upon impact on said impact plate; anda vibration sensor associated with said impact plate to register each said vibration response and send a corresponding signal to said PLC.

17. The control system of claim 16 wherein said vibration sensor is a piezoelectric sensor.

18. The control system of claim 10 wherein said sensor detecting a presence of particulate material carryover within the flow of dirty air discharged from the discharge air opening is an optical sensor mounted to detect carryover particulate material within the flow of dirty air.
